(19) United States
(12) Patent Application Publication
(10) Pub. No.: US 2013/0152473 A1
(43) Pub. Date: Jun. 20, 2013

(54) SLIDING DOOR

(71) Applicant: KEIHIN CORPORATION, Tokyo (JP)

(72) Inventor: Daisuke YOSHIKAWA, Tochigi-ken (JP)

(73) Assignee: KEIHIN CORPORATION, Tokyo (JP)

(21) Appl. No.: 13/713,319

(22) Filed: Dec. 13, 2012

(30) Foreign Application Priority Data
Dec. 16, 2011 (JP) 2011-275738

(51) Int. Cl. E06B 3/42

(52) U.S. Cl. CPC E06B 3/42
USPC 49/41

(57) ABSTRACT

A sliding door that includes a shield plate which has an inner surface curved along an inner side of a predetermined arc and an outer surface curved along an outer side of the arc, and a guide portion which is provided at a side of the shield plate and slidably supports the shield plate. The sliding door comprises a receiving portion, when the sliding doors are disposed to be layered by facing the inner surface and the outer surface of each of the shield plates, which allows the other sliding door located above to be received and supported.

Priority is claimed on Japanese Patent Application No. 2011-275738, filed Dec. 16, 2011, the disclosure of which is hereby incorporated herein by reference in its entirety.

### BACKGROUND

1. Field of the Invention

The present invention relates to a sliding door.

2. Description of Related Art

An air conditioning apparatus for a vehicle is to supply conditioned air of which a temperature or the like is regulated into a vehicle interior. The air conditioning apparatus for a vehicle includes a case having an air passage therein, and a heater core or an evaporator disposed in the middle of the air passage. Such an air conditioning apparatus for a vehicle regulates a temperature or humidity of air supplied from the outside with the heater core or the evaporator and supplies the regulated air as the conditioned air into the vehicle interior.

The air conditioning apparatus for a vehicle generally includes a frame which is integral with the case. The frame is formed with a plurality of openings disposed in the middle of the air passage. That is, air flows through the openings provided in the frame. For example, the frame is provided with a heating opening to supply the air cooled by the evaporator to the heater core, or a cold air opening to bypass the heater core. In such an air conditioning apparatus for a vehicle, a ratio of the air, which passes through the heating opening and the cold air opening, is adjusted, and thereby the temperature of the conditioned air is regulated.

The ratio of the air passing through the heating opening and the cold air opening is adjusted by moving a sliding door which changes an aperture ratio of the heating opening and the cold air opening arranged adjacent to each other.

For example, the sliding door is curved along a predetermined arc and is slidable along the arc as disclosed in Japanese Unexamined Patent Application, First Publication No. 2011-57044.

### SUMMARY

Incidentally, in a case of mass producing the above-mentioned air conditioning apparatus for a vehicle, the assembly of the air conditioning apparatus for a vehicle is performed by a conveyor system. For this reason, there is a need to transport a plurality of to-be-assembled sliding doors to an assembly site. In this case, it is preferable to stack and transport the sliding doors. However, if the sliding doors are stacked, there is a possibility of any of the sliding doors being entirely distorted due to the weight of the other sliding doors and the end portion of a guide portion being deformed, thereby not being smoothly moved.

In addition, high dimensional accuracy is required for each curved sliding door in order for the sliding door to be smoothly moved. However, when the sliding door is entirely curved, it is difficult to accurately measure the dimensions of the sliding door in the absence of a standard for measuring the thickness of the sliding door.

Aspects according to the present invention has been made in view of the above-mentioned problems, and an object thereof is to be able to suppress deformation of a sliding door, which is installed in an air conditioning apparatus for a vehicle, during the transport of the sliding door and to easily and accurately measure the dimensions thereof

Aspects according to the present invention adopt the following configurations as means for solving the above-mentioned problems.
(1) In accordance with an aspect of the present invention, a sliding door that includes a shield plate which has an inner surface curved along an inner side of a predetermined arc and an outer surface curved along an outer side of the arc, and a guide portion which is provided at a side of the shield plate and slidably supports the shield plate, the sliding door includes a receiving portion, when the sliding doors are disposed to be layered by facing the inner surface and the outer surface of each of the shield plates, which allows the other sliding door located above to be received and supported.
(2) In the aspect as (1) described above, when the sliding door is in a first loading position where the inner surface of the shield plate is directed downward and the outer surface of the shield plate is directed upward, the receiving portion may have a first surface which is directed downward and is horizontal and a second surface which is directed upward and is horizontal immediately above the first surface, and the first and second surfaces may be flat surfaces.
(3) In the aspect as (2) described above, when the sliding doors are layered in the first loading position, the first surface may be disposed at a position coming into contact with a second surface of a receiving portion of the other sliding door located below or a loading surface, and when the sliding doors are layered in the first loading position, the second surface may be disposed at a position coming into contact with a first surface of a receiving portion of the other sliding door located above.
(4) In the aspect as (3) described above, the receiving portion may have a convex portion of which a fore-end protrudes further downward than the shield plate when the sliding door is in the first loading position, and the first surface may be configured by a fore-end surface of the convex portion.
(5) In the aspect as (4) described above, the receiving portion may have a concave portion dug on the guide portion, and the second surface may be configured by a bottom surface of the concave portion.
(6) In any one of the aspects as (1) to (5) described above, the sliding door may further include a seal member that extends from an end portion in a sliding direction of the shield plate in the sliding direction and comes into contact with a frame having an opening of which an aperture ratio is adjusted by the sliding door.
(7) In any one of the aspects as (1) to (6) described above, when the sliding door is in a second loading position where the outer surface of the shield plate is directed downward and the inner surface of the shield plate is directed upward, a support portion, which comes into contact with a loading surface and supports the shield plate, the guide portion, and the seal member, may be provided in the outer surface side of the shield plate.
(8) In the aspect as (7) described above, when the sliding doors are disposed to be layered by facing the inner surface and the outer surface of each of the shield plates, a fitting groove, which is fitted with a support portion of the other sliding door neighboring in an upward and downward direction, may be provided in the inner surface side of the shield plate.

The sliding door of the above-mentioned aspect includes the receiving portion and the receiving portion allows the other sliding door located above to be received and supported. Therefore, a load arising from the weight of the other sliding door located above may be inhibited from acting on a part other than the receiving portion. That is, the aspect according to the present invention, the load arising from the weight of the other sliding door acts uniformly on only a particular position of the sliding door, thereby enabling deformation of a part other than the receiving portion to be prevented. Accordingly, when the sliding doors are stacked to be transported, the deformation of the sliding doors may be prevented.

In addition, since the sliding door of the above-mentioned aspect includes the receiving portion, the dimensions may be measured based on the receiving portion. That is, the aspect according to the present invention, the dimensions may be easily measured always at the same position with respect to the sliding doors. Accordingly, the dimensions of the sliding door may be accurately evaluated.

In accordance with the aspects according to the present invention, in the sliding door installed in the air conditioning apparatus for a vehicle, it may be possible to suppress the deformation of the sliding door during the transport thereof and easily and accurately measure the dimensions thereof.

### BRIEF DESCRIPTION OF THE DRAWINGS

FIG. 1 is a cross-sectional view illustrating a schematic configuration of an air conditioning apparatus for a vehicle including a sliding door according to an embodiment of the present invention.

FIG. 2A is a perspective view when viewing the inner surface side of the sliding door.

FIG. 2B is a perspective view when viewing the outer surface side of the sliding door.

FIG. 3A is an entire side view of the sliding door.

FIG. 3B is an enlarged side view of an end portion of the sliding door.

FIG. 4A is a side view illustrating a state where the sliding doors are in a first loading position and are laminated.

FIG. 4B is a side view illustrating a state where the sliding door is in a second loading position.

### DESCRIPTION OF THE EMBODIMENTS

Hereinafter, a sliding door of an embodiment according to the present invention will be described with reference to the accompanying drawings. Also, the scale of each member is appropriately modified in order to make a recognizable size of the member in the drawings described below.

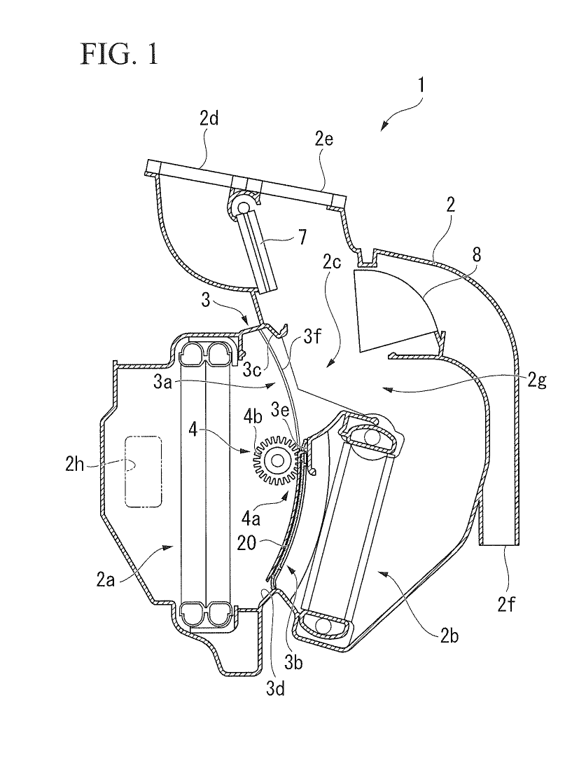

FIG. 1 is a longitudinal cross-sectional view illustrating a schematic configuration of an air conditioning apparatus for a vehicle 1, for the purpose of HVAC (Heating, Ventilation, and Air Conditioning), including a sliding door 20 according to an embodiment of the present invention. As shown in this drawing, the air conditioning apparatus for a vehicle 1 includes a case 2, a frame 3, an air mix damper device 4, an evaporator 5, a heater core 6, a mode switching damper 7, and a foot outlet mode damper 8.

The case 2 defines an external shape of the air conditioning apparatus for a vehicle 1. The case 2 includes therein a cooling passage 2a installed with the evaporator 5, a heating passage 2b installed with the heater core 6, and a mixing portion 2c which generates conditioned air by mixing cold air (airflow) and warm air (airflow). In addition, the case 2 is provided with a plurality of outlets (a defroster outlet 2d, a face outlet 2e, and a foot outlet 2f) which is exposed to the outside and connected with the mixing portion 2c.

The defroster outlet 2d is an opening to supply the conditioned air with respect to a window.

In addition, the face outlet 2e is an opening to supply the conditioned air with respect to the face of a passenger.

In addition, the foot outlet 2f is an opening to supply the conditioned air with respect to the feet of a passenger.

Furthermore, the case 2 includes therein a warm air opening 2g which supplies the warm air from the heating passage 2b installed with the heater core 6 to the mixing portion 2c.

The case 2 includes an opening 2h provided in the upstream side of the evaporator 5, and air is sent from the opening 2h into the case 2 by an air blower (not shown).

The frame 3 includes a cold air opening 3a which supplies the cold air from the cooling passage 2a installed with the evaporator 5 to the mixing portion 2c, and a heating opening 3b which supplies the cold air form the cooling passage 2a to the heating passage 2b. The frame 3 is integral with the case 2 and is provided within the case 2.

In addition, the frame 3 has an upper side seal surface 3c which comes into contact with the sliding door 20 of the present embodiment when the sliding door 20 closes the cold air opening 3a, and a lower side seal surface 3d which comes into contact with the sliding door 20 when the sliding door 20 closes the heating opening 3b. In addition, the frame 3 has an intermediate seal surface 3e, which is disposed between the cold air opening 3a and the heating opening 3b, comes into contact with an edge portion (a lower side seal member 26b to be described later) of the lower side of the sliding door 20 when the sliding door 20 closes the cold air opening 3a, and comes into contact with an edge portion (an upper side seal member 26a to be described later) of the upper side of the sliding door 20 when the sliding door 20 closes the heating opening 3b.

In more detail, in the present embodiment, the cold air opening 3a is provided upward and the heating opening 3b is provided downward, as shown in FIG. 1. A portion of a wall surface of the frame 3, which is located upward of the cold air opening 3a, is the upper side seal surface 3c, and the upper side seal surface 3c comes into contact with the edge portion (the upper side seal member 26a to be described later) of the upper side of the sliding door 20 when the sliding door 20 closes the cold air opening 3a. In addition, a portion of the wall surface of the frame 3, which is located downward of the heating opening 3b, is the lower side seal surface 3d, and the lower side seal surface 3d comes into contact with the edge portion (the lower side seal member 26b to be described later) of the lower side of the sliding door 20 when the sliding door 20 closes the heating opening 3b.

In addition, the frame 3 has guide rails 3f to guide the sliding door 20 at sides of the frame 3. The guide rails 3f are provided at the opposite sides of the frame 3 with interposing the sliding door 20 therebetween.

As shown in FIG. 1, each of the guide rails 3f is curved along a predetermined arc so that a center of the guide rail 3f in a height direction thereof is recessed at the evaporator 5 side and swells at the heater core 6 side.

The air mix damper device 4 is disposed in the downstream side of the evaporator 5 and is to adjust a supply amount of the cold air, which is generated by the evaporator 5, to the heating passage 2b. In more detail, the air mix damper device 4 includes the sliding door 20 which is slidable between the cold air opening 3a and the heating opening 3b, and rack and pinion mechanisms 4a to drive the sliding door 20. That is, the sliding door 20 of the present embodiment is included as a component of the air mix damper device 4.

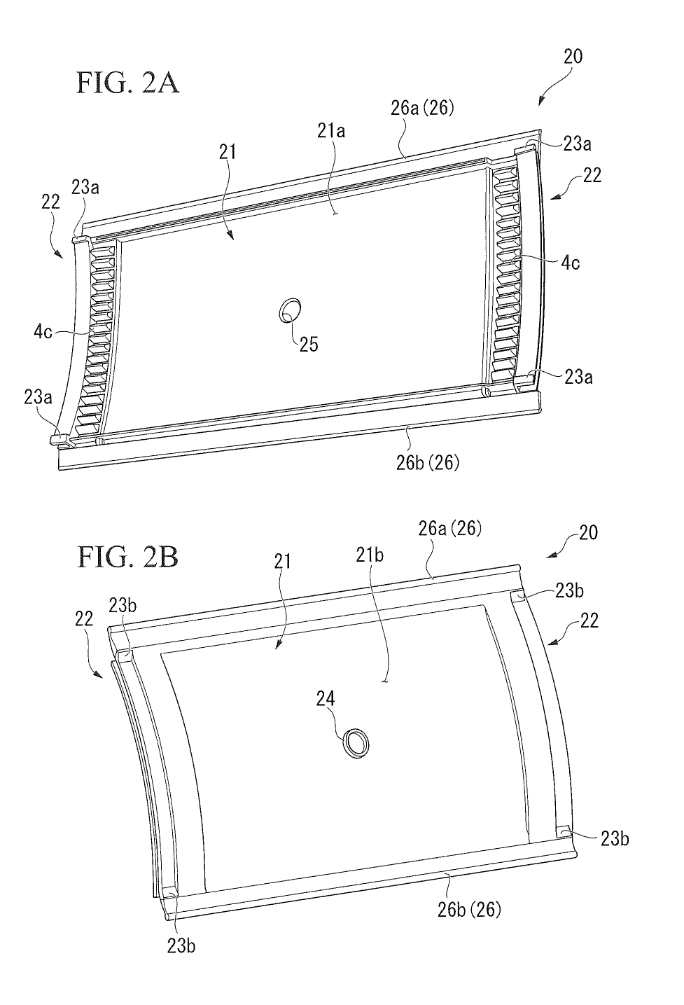

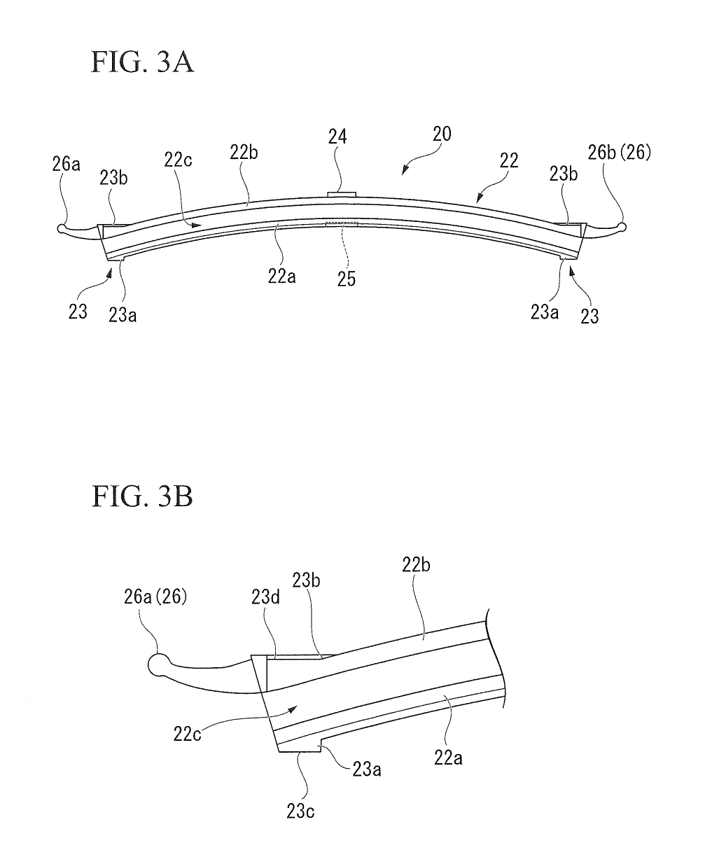

FIG. 2A is a perspective view when viewing the inner surface side of the sliding door 20. FIG. 2B is a perspective view when viewing the outer surface side of the sliding door 20. FIG. 3A is an entire side view of the sliding door 20. FIG. 3B is an enlarged side view of an end portion of the sliding door 20.

As shown in these drawings, the sliding door 20 includes a shield plate 21, guide portions 22, receiving portions 23, a support portion 24, a fitting groove 25, and a seal member 26.

The shield plate 21 is a curved plate made of a resin material. The shield plate 21 has an inner surface 21a which is curved along the inner side of a predetermined arc, and an outer surface 21b which is curved along the outer side of the predetermined arc. The inner surface 21a and the outer surface 21b are curved in parallel with each other because of being curved along the inner side and the outer side of the same arc. Furthermore, the inner surface 21a is directed to the evaporator 5 side and the outer surface 21b is directed to the heater core 6 side.

The guide portions 22 are provided at sides of the shield plate 21, and each of the guide portions 22 is part which is connected to the guide rail 3f provided at the frame 3. The guide portion 22 includes a first rib 22a which is curved and formed at the inner surface 21a side of the shield plate 21, a second rib 22b which is curved and formed at the outer surface 21b side of the shield plate 21, and a guide groove 22c formed by the first rib 22a and the second rib 22b. In addition, the first rib 22a and the second rib 22b are curved so that the guide groove 22c and the guide rail 3f have the same curvature. Such a guide portion 22 is connected to be slidable with respect to the guide rail 3f by fitting the guide groove 22c to the guide rail 3f. In addition, the shield plate 21 is supported to be slidable with respect to the frame 3 by the guide portion 22.

Each of the receiving portions 23 is constituted by a convex portion 23a provided on the inner surface 21a side of the shield plate 21 and a concave portion 23b provided on the outer surface 21b side of the shield plate 21.

The convex portion 23a is provided at the first rib 22a and protrudes from the first rib 22a to the opposite side to the second rib 22b. The convex portion 23a has, at a fore-end thereof, a height protruding further downward than the shield plate 21 when the sliding door 20 is in a first loading position (a position shown in FIG. 3B) where the inner surface 21a of the shield plate 21 is directed downward and the outer surface 21b of the shield plate 21 is directed upward. In addition, the convex portion 23a has a fore-end surface 23c (a first surface), and the fore-end surface 23c is a flat surface which is directed downward and is horizontal when the sliding door 20 is in the first loading position.

The concave portion 23b is provided at the second rib 22b and is formed by digging down into an outside surface of the second rib 22b to the first rib 22a side. The concave portion 23b has a bottom surface 23d (a second surface), and the bottom surface 23d is a flat surface which is directed upward and is horizontal when the sliding door 20 is in the first loading position.

As shown in FIG. 3B, the convex portion 23a and the concave portion 23b are aligned with each other in an upward and downward direction when the sliding door 20 is in the first loading position.

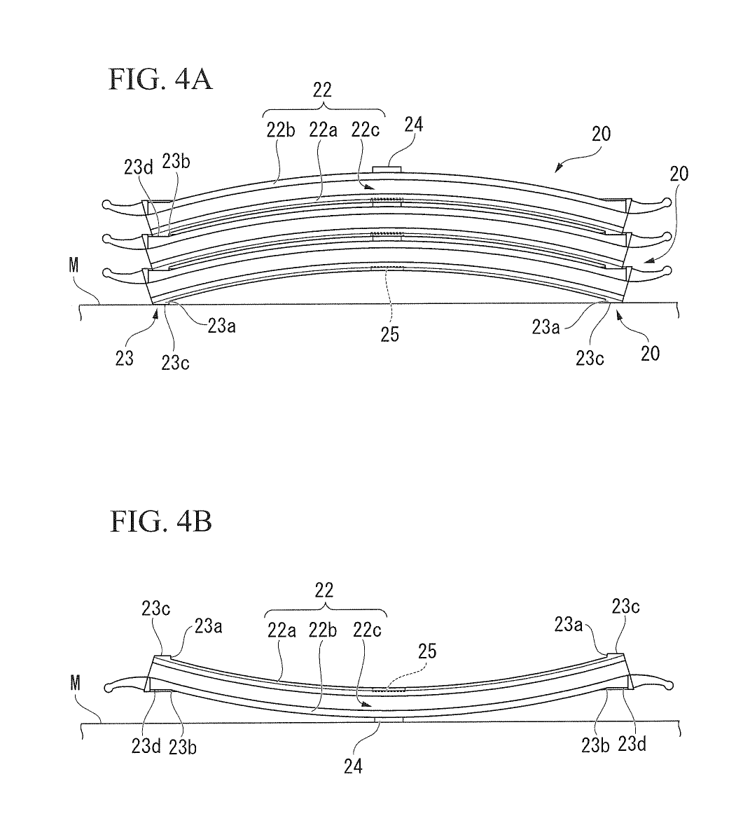

As shown in FIG. 4A, when the sliding doors 20 are layered in the form of the first loading position, this receiving portion 23 comes into contact with an associated receiving portion 23 of other sliding door 20 which is located above, thereby supporting the other sliding door 20 which is located above.

In addition, when the sliding doors 20 are layered in the form of the first loading position, each convex portion 23a of an upper sliding door 20 is fitted in an associated concave portion 23b of a lower sliding door 20 and a fore-end surface 23c of the convex portion 23a directed to the upper side comes into contact with a bottom surface 23d of the concave portion 23b directed to the lower side. Furthermore, each fore-end surface 23c of a sliding door 20 which is disposed at the lowest portion comes into contact with a loading surface M.

That is, when the sliding doors 20 are layered in the form of the first loading position, the fore-end surface 23c of the convex portion 23a is disposed at a position coming into contact with the bottom surface 23d of the concave portion 23b included in the receiving portion 23 of the other sliding door 20. In addition, when the sliding doors 20 are layered in the form of the first loading position, the bottom surface 23d of the concave portion 23b is disposed at a position coming into contact with the fore-end surface 23c of the convex portion 23a included in the receiving portion 23 of the other sliding door 20.

On the contrary, even when the sliding doors 20 are layered and disposed so that the inner surface 21a of the shield plate 21 is directed upward, similarly to the above configuration, the fore-end surface 23c of the convex portion 23a comes into contact with the bottom surface 23d of the concave portion 23b and the other sliding door 20 located above is supported by the receiving portion 23 of the sliding door 20 located below.

In addition, as shown in FIG. 1, the receiving portions 23 having the above-mentioned configuration are provided at opposite end portions of each guide portion 22 in the sliding direction of sliding door 20. That is, in the sliding door 20 of the present embodiment, the receiving portions 23 are provided at four corner portions.

The support portion 24 is a ring member provided to protrude from the outer surface 21b of the shield plate 21 at a center thereof. As shown in FIG. 4B, the support portion 24 is part which comes into contact with the loading surface M when the sliding door 20 is in a second loading position where the outer surface 21b of the shield plate 21 is directed downward and the inner surface 21a of the shield plate 21 is directed upward. When coming into contact with the loading surface M, the support portion 24 supports the shield plate 21, the guide portions 22, and the receiving portions 23, and functions as a leg portion to allow the sliding door 20 to be stable and independent.

The fitting groove 25 is formed at a center of the inner surface 21a of the shield plate 21. That is, the fitting groove 25 is formed at the back side of the support portion 24. The fitting groove 25 is a circular groove. The fitting groove 25 is fitted in a support portion 24 of a sliding door 20 neighboring in the upward and downward direction when the sliding doors 20 are layered and disposed by facing the inner surface 21a and the outer surface 21b of each of the shield plates 21.

The seal member 26 is a part which extends outward from opposite ends of the shield plate 21 in the sliding direction of the sliding door 20. The seal member 26 comes into contact with the upper side seal surface 3c of the frame 3 having the cold air opening 3a and the heating opening 3b, the lower side seal surface 3d, or the intermediate seal surface 3e. Furthermore, when the sliding door 20 completely closes the cold air opening 3a, the seal member 26 located at the upper side (hereinafter, referred to as the upper side seal member 26a) comes into contact with the upper side seal surface 3c and the seal member 26 located at the lower side (hereinafter, referred to as the lower side seal member 26b) comes into contact with the intermediate seal surface 3e. In addition, when the sliding door 20 completely closes the heating opening 3b, the upper side seal member 26a comes into contact with the intermediate seal surface 3e and the lower side seal member 26b comes into contact with the lower side seal surface 3d.

Turning back to FIG. 1, each of the rack and pinion mechanisms 4a is a mechanism to slide the sliding door 20. The rack and pinion mechanism 4a include a pinion 4b which is rotatably driven by transfer of power from a motor (not shown), and a rack 4c (see FIGS. 2A and 2B) which converts rotational power of the pinion into linear power and transfers the linear power to the sliding door 20. Furthermore, the rack 4c of the rack and pinion mechanism 4a is integrally formed with the sliding door 20.

The heater core 6 is disposed within the heating passage 2b and is to generate the warm air by heating the cold air supplied through the heating opening 3b.

The mode switching damper 7 is a damper to perform the opening and closing of the defroster outlet 2d and the opening and closing of the face outlet 2e and is rotatably constituted within the case 2.

The foot outlet mode damper 8 is a damper to perform the opening and closing of the foot outlet 2f and is rotatably constituted within the case 2.

Furthermore, the air mix damper device 4, the mode switching damper 7, and the foot outlet mode damper 8 are supplied with power from the motor (not shown).

In the air conditioning apparatus for a vehicle 1 having such a configuration, when both of the cold air opening 3a and the heating opening 3b are opened by the air mix damper device 4, the air supplied to the cooling passage 2a is cooled by the evaporator 5 to become the cold air and a portion of the cold air is supplied to the heating passage 2b.

The warm air, which is generated by heating of the heater core 6 in the heating passage 2b, is supplied from the warm air opening 2g to the mixing portion 2c, and the other cold air which is not supplied to the heating passage 2b is supplied from the cold air opening 3a to the mixing portion 2c.

The cold air and warm air, which are supplied to the mixing portion 2c, are mixed to become the conditioned air, and the conditioned air is supplied into the vehicle interior from any one of the defroster outlet 2d, the face outlet 2e, and the foot outlet 2f, which is opened.

In accordance with the sliding door 20 of the present embodiment included in the above air conditioning apparatus for a vehicle 1, each of the receiving portions 23 is provided separately from the shield plate 21 and the guide portion 22 and allows the other sliding door 20 located above to be received and supported. Therefore, a load arising from the weight of the other sliding door 20 located above may be inhibited from acting on a part other than the receiving portion 23. That is, according to the sliding door 20 of the present embodiment, the load arising from the weight of the other sliding door 20 acts uniformly on only a particular position of the sliding door 20, thereby enabling deformation of a part other than the receiving portion 23 to be prevented. Accordingly, when the sliding doors 20 are stacked to be transported, sliding deformation of the sliding door 20 may be prevented.

In addition, since the sliding door 20 of the present embodiment includes the receiving portion 23, the dimensions may be measured based on the receiving portion 23. That is, according to the sliding door 20 of the present embodiment, the dimensions may be easily measured always at the same position with respect to the sliding doors 20. Accordingly, the dimensions of the sliding door 20 may be accurately evaluated.

In accordance with the sliding door 20 of the present embodiment, it may be possible to suppress deformation of the sliding door during the transport thereof and easily and accurately measure the dimensions thereof.

In addition, when the sliding door 20 of the present embodiment is in the first loading position, the receiving portion 23 includes the fore-end surface 23c and the bottom surface 23d which are horizontal. Since the fore-end surface 23c and the bottom surface 23d are parallel to each other and are the flat surfaces, a clearance therebetween may be measured easily and accurately with the vernier calipers, etc. Accordingly, according to the sliding door 20 of the present embodiment, the dimensions may be measured more easily and accurately.

In addition, according to the sliding door 20 of the present embodiment, when the sliding doors 20 are layered, the fore-end surface 23c of the upper sliding door 20 comes into contact with the bottom surface 23d of the lower sliding door 20. Since the fore-end surface 23c and the bottom surface 23d are the flat surfaces, the sliding doors 20 may be stably layered.

In addition, according to the sliding door 20 of the present embodiment, when the sliding door 20 is in the first loading position, the height of the convex portion 23a is set so as to protrude further downward than the shield plate 21 at the fore-end of the convex portion 23a. For this reason, when the fore-end surface 23c comes into contact with the loading surface M, there is no case in which the shield plate 21 or the guide portion 22 touches the loading surface M. Consequently, the shield plate 21 or the guide portion 22 may be more reliably prevented from being deformed.

In addition, according to the sliding door 20 of the present embodiment, when the receiving portion 23 includes the concave portion 23b and the sliding doors 20 are layered, the bottom surface 23d of the concave portion 23b comes into contact with the fore-end surface 23c of the convex portion 23a of the other sliding door 20. That is, when the sliding doors 20 are layered, the convex portion 23a is fitted in the concave portion 23b of the other sliding door 20. Therefore, the layered sliding doors 20 may be hindered from collapsing, thereby being easily transported.

In addition, according to the sliding door 20 of the present embodiment, the seal member 26 is provided to extend from the shield plate 21. When the sliding doors 20 are layered, there is no case in which the seal member 26 comes into contact with other members. For this reason, according to the sliding door 20 of the present embodiment, the seal member 26 may be prevented from being deformed. Furthermore, a gap between the shield plate 21 and the seal surface (the upper side seal surface 3c, the lower side seal surface 3d, and the intermediate seal surface 3e) may be reliably sealed.

In addition, when the sliding door 20 is in the second loading position, the sliding door 20 of the present embodiment includes the support portion 24 which comes into contact with the loading surface M and supports the shield plate 21, the guide portion 22, the receiving portion 23, and the seal member 26. Therefore, even when the sliding door 20 is in the second loading position, the shield plate 21, the guide portion 22, and the seal member 26 may be prevented from coming into contact with the loading surface M. Furthermore, the shield plate 21, the guide portion 22, and the seal member 26 may be prevented from being deformed.

In addition, when the sliding doors 20 are layered, the sliding door 20 of the present embodiment includes the fitting groove 25 fitted with the support portion 24. Therefore, when the sliding doors 20 are layered, the sliding doors 20 may be prevented from collapsing.

While the preferred embodiment of the invention has been described with reference to the accompanying drawings, the present invention is not limited to only the above embodiment. Various shapes, combinations or the like illustrated in the above-mentioned embodiment serve as an example, and various modifications and variations can be made based on the design requirement and the like without departing from the spirit or scope of the present invention.

For example, in the above embodiment, the configuration has been described in which the fore-end surface 23c and the bottom surface 23d are the flat surfaces. However, the present invention is not limited thereto, and the fore-end surface or the bottom surface configured by a rough surface may be adopted.

In addition, the fore-end surface and the bottom surface may also be configured by convex and concave surfaces which are fitted to each other. In this case, when the sliding doors 20 are layered, the sliding doors 20 may be more reliably prevented from collapsing.

In addition, in the above embodiment, an example has been described in which the sliding door of the present invention is applied with respect to the air conditioning apparatus for a vehicle including one sliding door. However, there is also an air conditioning apparatus for a vehicle in which the inside of a case is divided into the driver seat side and the passenger seat side, and the temperatures of the driver seat side and the passenger seat side are independently regulated in two sliding doors. The sliding door of the present invention may also be applied to an air conditioning apparatus for a vehicle including such two sliding doors.

What is claimed is:

1. A sliding door that includes a shield plate which has an inner surface curved along an inner side of a predetermined arc and an outer surface curved along an outer side of the arc, and a guide portion which is provided at a side of the shield plate and slidably supports the shield plate, the sliding door comprising:
a receiving portion, when the sliding doors are disposed to be layered by facing the inner surface and the outer surface of each of the shield plates, which allows the other sliding door located above to be received and supported.

2. The sliding door according to claim 1, wherein when the sliding door is in a first loading position where the inner surface of the shield plate is directed downward and the outer surface of the shield plate is directed upward, the receiving portion has a first surface which is directed downward and is horizontal and a second surface which is directed upward and is horizontal immediately above the first surface, and the first and second surfaces are flat surfaces.

3. The sliding door according to claim 2,
wherein when the sliding doors are layered in the first loading position, the first surface is disposed at a position coming into contact with a second surface of a receiving portion of the other sliding door located below or a loading surface, and
wherein when the sliding doors are layered in the first loading position, the second surface is disposed at a position coming into contact with a first surface of a receiving portion of the other sliding door located above.

4. The sliding door according to claim 3,
wherein the receiving portion has a convex portion of which a fore-end protrudes further downward than the shield plate when the sliding door is in the first loading position, and
wherein the first surface is configured by a fore-end surface of the convex portion.

5. The sliding door according to claim 4,
wherein the receiving portion has a concave portion dug on the guide portion, and
wherein the second surface is configured by a bottom surface of the concave portion.

6. The sliding door according to claim 1, further comprising:
a seal member that extends from an end portion in a sliding direction of the shield plate in the sliding direction and comes into contact with a frame having an opening of which an aperture ratio is adjusted by the sliding door.

7. The sliding door according to claim 1, wherein when the sliding door is in a second loading position where the outer surface of the shield plate is directed downward and the inner surface of the shield plate is directed upward, a support portion, which comes into contact with a loading surface and supports the shield plate, the guide portion, and the seal member, is provided in the outer surface side of the shield plate.

8. The sliding door according to claim 7, wherein when the sliding doors are disposed to be layered by facing the inner surface and the outer surface of each of the shield plates, a fitting groove, which is fitted with a support portion of the other sliding door neighboring in an upward and downward direction, is provided in the inner surface side of the shield plate.
